(19) United States
(12) Patent Application Publication
(10) Pub. No.: US 2018/0043711 A1
(43) Pub. Date: Feb. 15, 2018

(54) DEVICE TO GUIDE A BAND-SHAPED RECORDING MEDIUM BETWEEN SUCCESSIVELY ARRANGED PRINT GROUPS IN A PRINTING APPARATUS

(71) Applicant: Océ Holding B.V., Venlo (NL)

(72) Inventors: Arjen Wind, Eindhoven (NL); Robert Sigismund, Putzbrunn (DE); Robert Kargl, Muenchen (DE)

(73) Assignee: Océ Holding B.V., Venlo (NL)

(21) Appl. No.: 15/674,740

(22) Filed: Aug. 11, 2017

(30) Foreign Application Priority Data
Aug. 12, 2016 (DE) 10 2016 115 014.2

(51) Int. Cl. B41J 15/04

(52) U.S. Cl. CPC B41J 15/048

(57) ABSTRACT

A device to turn band-shaped recording media between two print groups is described. The device can include an observation region for the printing region that extends across at least one print side. Water-cooled cooling rollers can be arranged in the intake region of the turning device to cool the recording medium.

### CROSS REFERENCE TO RELATED APPLICATIONS

This patent application claims priority to German Patent Application No. 102016115014.2, filed Aug. 12, 2016, which is incorporated herein by reference in its entirety.

### BACKGROUND

The present disclosure is directed to a device to guide and/or turn a band-shaped recording medium between successively arranged print groups in a printing apparatus, in particular an ink printing apparatus.

An example printing apparatus is described in detail in DE 102013107451 A1 or U.S. Pat. No. 5,467,179.

In a first print group, the front side of a paper web is thereby printed to with a printing medium (for example ink or toner), then is turned and supplied to a second print group for printing to the back side. It is typical to use a thermal fixing station to fix the printing medium onto the paper web.

One problem in such printing devices is error-free running without quality losses of the print image on the band-shaped recording medium due to the turning station—a cross-turner, for example—arranged between the print groups.

Band-shaped recording media (made of roll paper of different paper thicknesses, for example) are subject to a thermal stress with embrittlement upon fixing in the fixing station, and then may easily be damaged by the following repeated deflection.

Furthermore, the monitoring of the print quality and of the paper transport is important in order to promptly detect disruptions, for example.

### BRIEF DESCRIPTION OF THE DRAWINGS/FIGURES

The accompanying drawings, which are incorporated herein and form a part of the specification, illustrate the embodiments of the present disclosure and, together with the description, further serve to explain the principles of the embodiments and to enable a person skilled in the pertinent art to make and use the embodiments.

FIG. 1 illustrates a printing device having two printing stations and a turning station arranged between them, with an elongated visibility region, according to an exemplary embodiment of the present disclosure.

FIG. 2 illustrates an example of the turning station having an elongated visibility region according to an exemplary embodiment of the present disclosure.

The exemplary embodiments of the present disclosure will be described with reference to the accompanying drawings.

### DETAILED DESCRIPTION

In the following description, numerous specific details are set forth in order to provide a thorough understanding of the embodiments of the present disclosure. However, it will be apparent to those skilled in the art that the embodiments, including structures, systems, and methods, may be practiced without these specific details. The description and representation herein are the common means used by those experienced or skilled in the art to most effectively convey the substance of their work to others skilled in the art. In other instances, well-known methods, procedures, components, and circuitry have not been described in detail to avoid unnecessarily obscuring embodiments of the disclosure.

Exemplary embodiments of the present disclosure include a device configured to guide a band-shaped recording medium between successively arranged print groups, which device is designed to be gentle to paper and insusceptible to disruption.

Exemplary embodiments can include a device that is configured to enable an easy monitoring of the printing process.

The device according to exemplary embodiments can include a turning device, such as a cross-turner, that is configured to turn band-shaped recording media between two print groups. The turning device can include a special observation region (e.g. running orthogonally) for monitoring of the printing process. The observation region can be for the printing region that extends at least across one print side.

The print image printed onto the front side of the paper web therefore can simply be monitored with regard to its printing parameters such as printing offset, color accuracy and information content.

Furthermore, the elongated visibility region additionally cools the recording medium before the new printing to the back side in the following print group.

Water-cooled cooling rollers arranged in the region of the turning device additionally cool the paper web having a thermally fixed print image before said paper web is supplied to the visibility region, and thus prevent a fold formation or creasing. Furthermore, the paper web is thereby brought to a defined temperature before it is printed to on the back side in the following print group.

In an additional advantageous embodiment of the present disclosure, an optical scanning device (a camera, for example) is provided. The optical scanning device can be associated with the turning device, and can be a component of a monitoring device configured to verify the first print image printed on the front side.

According to exemplary embodiments, the print image is thereby automatically detected and is subjected to a nominal/real comparison with regard to the printing parameter. A misprint can thus already be detected and, if applicable, corrected early.

In an exemplary embodiment, a display configured to present the nominal page—for example in the form of a PDF file—may be arranged below the visibility region to enable a current optical nominal/real comparison.

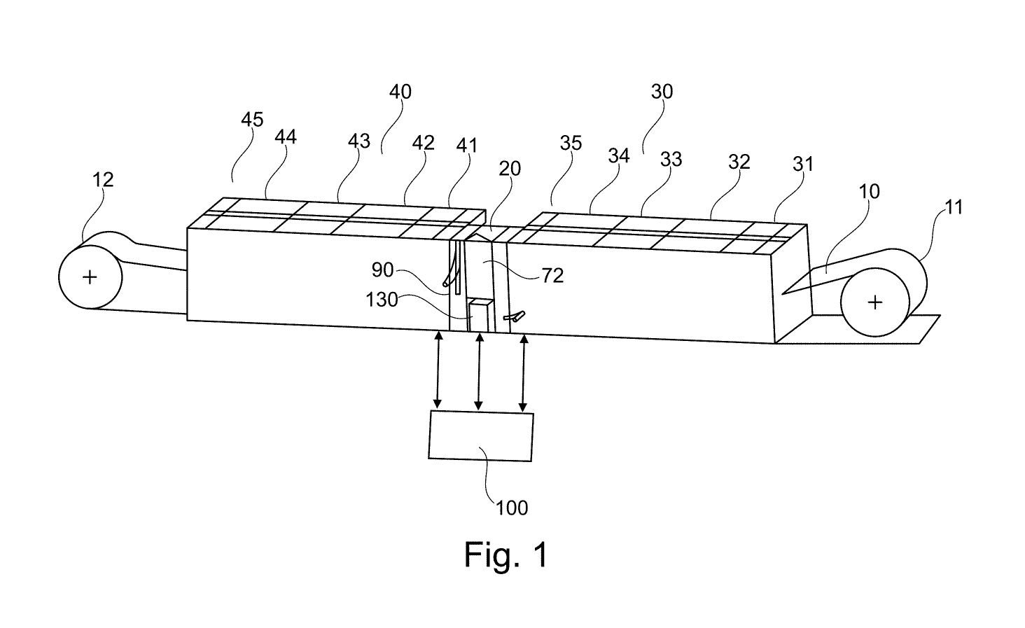

A printing route shown in FIG. 1 for two-sided printing to a band-shaped recording medium 10 can include two printing systems 30 and 40 coupled via a turning unit 20 designed as a cross-turner, with individual print groups 31, 32, 33, 34 and 41, 42, 43, 44 arranged therein and operating with liquid toner, dry toner or ink to generate the individual color separations. In an exemplary embodiment, the recording medium (e.g. paper) 10 is taken off from a supply roll 11, supplied to the printing systems 30, and printed to on the front side and fixed in a thermal fixing station 35. The recording medium 10 is then turned in a turning station 20, and the back side is printed to in a printing system 40 and fixed in a thermal fixing station 45 associated with the printing system. The recording medium 10 haven been printed to on both sides is then taken up in a take-up station 12.

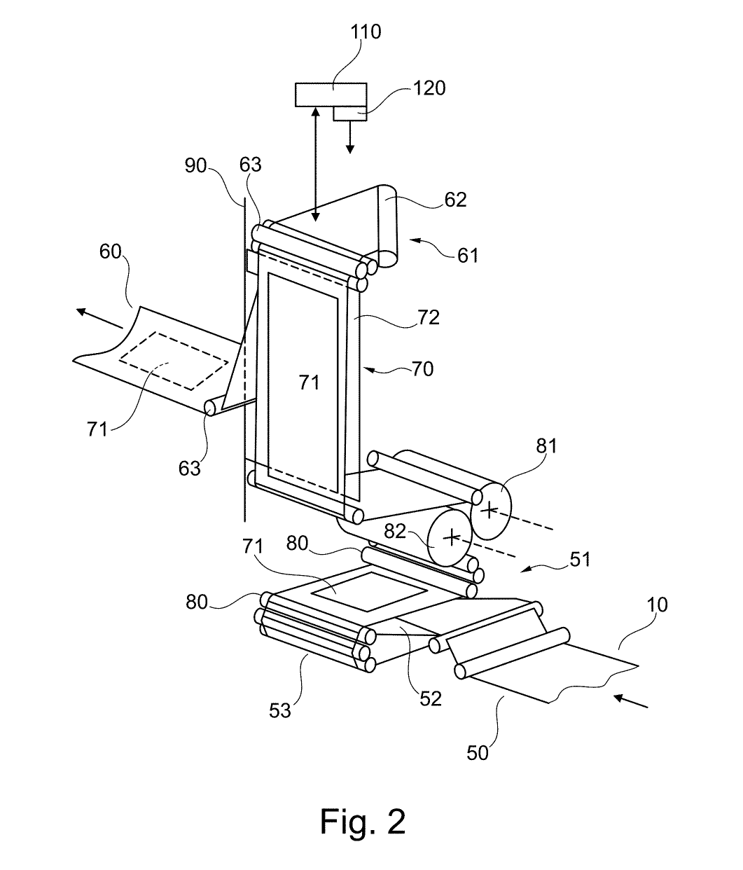

An exemplary embodiment of the turning station 20 is illustrated in FIG. 2. The turning station 20 can be designed as a cross-turner in an exemplary embodiment. In an exemplary embodiment, in a paper intake channel 50, the turning station 20 can include a first deflection device (e.g. deflector) 51 with a sloped guidance element (e.g. sloped guide roller) 52 and a graduated guidance element (e.g. graduated guide roller) 53 that deflects the paper web 10 from a supply direction with overhead printing region 71 into a visibility region 70 traveling orthogonal to this, with frontally visible printing region 71. The paper web 10 is thereby additionally guided via paper guidance rolls 80. Two motorized, water-cooled drive rolls 81, 82 upstream of the visibility region 70 serve as a cooling device in order to further cool the print image heated in the thermal fixing device 35, 45 before it is supplied to the visibility region 70. Via the cooling device, the recording medium 10 is adjusted to a defined temperature before the printing to the back side via the printing station 40.

In an exemplary embodiment, the orthogonally traveling visibility region 70 in turn has an observation region 72 for the printing region 71 that extends at least across a print page. It is therefore possible to observe the printing process and monitor the print quality.

In an exemplary embodiment, downstream of the visibility region 70 is a paper exit channel 60 having a second deflection device 61 that likewise has a sloped guidance element 62 and a graduated guidance element 64, which second deflection device 61 deflects the recording medium 10 supplied from the visibility region 70 in an exit direction with printing region 71 situated below (i.e. the other side of the recording medium 10).

In an exemplary embodiment, to protect the visibility region 70, the some or all of the turning station 20 can be arranged in a housing 90 with front-side viewing plate.

In an exemplary embodiment, it is also possible to arrange an additional visibility region (not shown here) in the paper exit channel 60 as a control region for the paper transport.

In an exemplary embodiment, in, for example, high-capacity printers having a high print speed (e.g. 1 m/sec or more), a control arrangement (e.g. controller) 100 (FIG. 1) can be provided. The control arrangement 100 can be connected with the drive devices of the printer and the turning station 20 to enable a quality control via reading and observing of the print image printed on the front side. After invoking a read mode, the drive of the paper web 10 is slowed intermittently so that the print images may easily be read through the visibility window in a slower operating cycle (e.g. slower than during a normal printing cycle). For example, control arrangement 100 can be configured to decrease the transport velocity of the recording medium 10 to a reading velocity based on a visibility function (e.g., the invocation of the reading mode). In an exemplary embodiment, the control arrangement 100 can include processor circuitry that is configured to perform one or more operations and/or functions of the control arrangement 100. In an exemplary embodiment, the control arrangement 100 is a controller (e.g. that can include processor circuitry).

In an exemplary embodiment, so that printing may continue further with the front-side printer 30, a paper length compensation device can be advantageously provided. In an exemplary embodiment, the paper length compensation device can be, for example, a loop puller. The paper length compensation device can be configured in the region of the turning device (turning station 20), such as in the intake region to the visibility region.

Turning to FIG. 2, in an exemplary embodiment, a scanner 110 with associated illumination device 120 (e.g. light source, such as light bulb, LED lamp, etc.)—for example in the form of a camera that is connected with the evaluation device—may also be arranged for automatic and continuous print quality monitoring or the paper drive. In an exemplary embodiment, the arrangement of the scanner 110 is advantageously in the intake region of the turning station 20, but is not limited thereto. In an exemplary embodiment, the scanner 110 (e.g. camera) can be configured to detect the print image and transmit the detected print image to an evaluation device that is configured to compare the detected print image with the current nominal print image called from the controller of the first printer 30. In operation, given corresponding deviations, the evaluation device generates (and possibly presents) evaluable warning signals. In an exemplary embodiment, the scanner 110 and/or illumination 120 can include processor circuitry that is configured to perform one or more operations and/or functions of the scanner 110/illumination 120.

In an exemplary embodiment, the nominal print image may be presented (for example in the form of a PDF file) via a display 130 arranged below the visibility region, which allows the operator a direct continuous monitoring.

### CONCLUSION

The aforementioned description of the specific embodiments will so fully reveal the general nature of the disclosure that others can, by applying knowledge within the skill of the art, readily modify and/or adapt for various applications such specific embodiments, without undue experimentation, and without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

References in the specification to “one embodiment,” “an embodiment,” “an exemplary embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The exemplary embodiments described herein are provided for illustrative purposes, and are not limiting. Other exemplary embodiments are possible, and modifications may be made to the exemplary embodiments. Therefore, the specification is not meant to limit the disclosure. Rather, the scope of the disclosure is defined only in accordance with the following claims and their equivalents.

Embodiments may be implemented in hardware (e.g., circuits), firmware, software, or any combination thereof. Embodiments may also be implemented as instructions stored on a machine-readable medium, which may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others. Further, firmware, software, routines, instructions may be described herein as performing certain actions. However, it should be appreciated that such descriptions are merely for convenience and that such actions in fact results from computing devices, processors, controllers, or other devices executing the firmware, software, routines, instructions, etc. Further, any of the implementation variations may be carried out by a general purpose computer.

For the purposes of this discussion, “processor circuitry” can include one or more circuits, one or more processors, logic, or a combination thereof. For example, a circuit can include an analog circuit, a digital circuit, state machine logic, other structural electronic hardware, or a combination thereof. A processor can include a microprocessor, a digital signal processor (DSP), or other hardware processor. In one or more exemplary embodiments, the processor can include a memory, and the processor can be “hard-coded” with instructions to perform corresponding function(s) according to embodiments described herein. In these examples, the hard-coded instructions can be stored on the memory. Alternatively or additionally, the processor can access an internal and/or external memory to retrieve instructions stored in the internal and/or external memory, which when executed by the processor, perform the corresponding function(s) associated with the processor, and/or one or more functions and/or operations related to the operation of a component having the processor included therein.

In one or more of the exemplary embodiments described herein, the memory can be any well-known volatile and/or non-volatile memory, including, for example, read-only memory (ROM), random access memory (RAM), flash memory, a magnetic storage media, an optical disc, erasable programmable read only memory (EPROM), and programmable read only memory (PROM). The memory can be non-removable, removable, or a combination of both.

### REFERENCE LIST

10 recording medium, paper web
11 stock roll
30, 40 printing systems
31, 32, 33, 34 individual print groups, printer 30
41, 42, 43, 44 individual print groups, printer 40
20 turning device
35,45 fixing station
12 take-up station
50 paper intake channel
51 first deflection element, deflection device
52 sloped guidance element
53 graduated guidance element
60 paper exit channel
60 second deflection element, deflection device
61 sloped guidance element
63 graduated guidance element
70 visibility region
71 printing region
72 observation region
80 paper guide rolls
81 water-cooled drive roll
82 water-cooled drive roll
90 housing
100 control arrangement
110 scanner, camera
120 illumination device
130 display

What is claimed is:

1. A device to guide a band-shaped recording medium between two print groups, the device comprising:
a paper intake channel including a first deflection device with a sloped guidance element and a graduated guidance element, the paper intake channel being configured to deflect the recording medium, having a printing region facing in an upward direction, from a supply direction into a visibility region and traveling orthogonal to the supply direction, wherein the visibility region is configured to frontally visibly present the printing region; and
a paper exit channel including a second deflection channel with a sloped guidance element and a graduated guidance element, the paper exit channel being configured to deflect the recording medium supplied from the visibility region in an exit direction with printing region facing in a downward direction, wherein the visibility region includes an observation region for the printing region that extends at least across a print side.

2. The device according to claim 1, further comprising: a cooling device arranged in a region of the paper intake channel.

3. The device according to claim 2, wherein the cooling device comprises at least one cooling roller.

4. The device according to claim 2, wherein the cooling device is a water-cooled cooling device.

5. The device according to claim 1, further comprising a controller that is configured to decrease the transport velocity of the recording medium to a reading velocity based on a visibility function.

6. The device according to claim 1, further comprising a housing including a viewing window that provides visible access to the visibility region.

7. The device according to claim 6, further comprising an illumination device associated with the printing region that is configured to illuminate the printing region.

8. The device according to claim 1, further comprising an optical scanning device associated with the printing region that is configured to optically scan the printing region.

9. The device according to claim 8, wherein the optical scanning device is configured to monitor optical parameters of the printing region.

10. The device according to claim 1, further comprising a display arranged adjacent to the visibility region and configured to display a nominal printing region for comparison to the printing region.

11. The device according to claim 1, further comprising a print group configured as an ink printing device.

12. A printer operable to print an image on a band-shaped recording medium
a first print group configured to print an image on a first side of the recording medium in a printing region;
a paper intake channel configured to accept the recording medium having the image printed on the first side of the recording medium, the paper intake channel including a first deflector with a sloped guide and a graduated guide, the paper intake channel being configured to deflect the recording medium, having the printing region facing in a first direction, from a supply direction into a visualizer and traveling orthogonal to the supply direction, wherein the visualizer is configured to present the printing region of the recording medium;
a paper exit channel including a second deflector with a sloped guide and a graduated guide, the paper exit channel being configured to deflect the recording medium supplied from the visualizer in an exit direction with printing region facing in a second direction opposite the first direction, wherein the visualizer includes an observation window for the printing region that extends at least across a print side of the recording medium; and
a second print group configured to:
receive the recording medium having the print region facing in the second direction; and
print another image on a second side of the recording medium opposite the first side in a second printing region of the recording medium.

13. The printer according to claim 12, wherein the paper intake channel and the paper exit channel are positioned between the first and the second print groups.

14. The printer according to claim 12, further comprising a controller that is configured to decrease the transport velocity of the recording medium to a reading velocity based on a visibility function.

15. The printer according to claim 14, wherein the reading velocity facilitates a visual inspection of the printed image in the printing region.
